(19) United States
(12) Patent Application Publication
(10) Pub. No.: US 2017/0306604 A1
(43) Pub. Date: Oct. 26, 2017

(54) Eliminate odor toilet with a jet device

(71) Applicant: Yahe Zhang, Richmond (CA)

(72) Inventor: Yahe Zhang, Richmond (CA)

(21) Appl. No.: 15/136,110

(22) Filed: Apr. 22, 2016

(51) Int. Cl. E03D 9/04; F15D 1/02

(52) U.S. Cl. CPC E03D 9/04; F15D 1/02

(57) ABSTRACT

This is the device that uses airflow to remove toilet odor, comprising a compressed air tube and a pipe. The compressed air tube blows air along the axis of a pipe, creating the high speed airflow inside the pipe, drawing the air behind to enter into and flow in the direction of the pipe, also drawing the toilet odor away. The embodiments in this application also describe a long pipe where both ends of the long pipe separately placed, with one end located at the area of concentrated odor, and the other end located at an area where the odor may be released, and a compressed air tube blowing air along the axis of the long pipe as a method to be able to remove odor.

### FIELD

The contents of this application involve toilets, specifically waterless toilets and straight toilets, such as toilets without an S shaped water seal, where the waste and dirty liquid is flushed directly out of the base of the toilet.

### SUMMARY

A device that uses airflow to remove toilet odor, said device comprising: a compressed air tube, and a pipe. The compressed air as in the said compressed air tube is quickly passed through the said pipe. The high speed airflow in interior of the said pipe draws the air in the rear of the pipe to enter the pipe and flow in the same direction that the pipe is facing, also drawing the toilet odor away. The structure of the device described in this specification is simple, and directly removes the odor. People who are familiar with this field may find other advantages to this invention after reading the complete specification.

### BRIEF DESCRIPTION OF THE DRAWINGS

FIG. 1 is a schematic diagram of some of the components of this application, a compressed air tub, and a pipe.

FIG. 2A to FIG. 2D are schematic diagrams of this application according to the first, the second, the third, and the forth embodiments, illustrating the relative positions between the compressed air tube and the pipe.

FIG. 3A to FIG. 3D are schematic diagrams of this application according to the fifth, the sixth, the seventh, and the eighth embodiments, illustrating the relative positions between the compressed air tube and the long pipe.

FIG. 4A is a schematic diagram of this application according to the ninth embodiment, showing a compressed air tube, and a pipe with continuous identical axial diameter. FIG. 4B is a schematic diagram of this application according to the ninth embodiment, showing a nozzle-shaped compress air tube, and a pipe in the shape of a Venturi pipe.

### SPECIFICATION AND EMBODIMENTS

A device that uses airflow to remove toilet odor, comprising: a compressed air tube, a pipe. The compressed air as in the said compressed air tube is quickly passed through the said pipe. The high speed airflow in interior of the said pipe draws the air in the rear of the pipe to enter the pipe and flow in the same direction that the pipe is facing, also drawing the toilet odor away.

The said compressed air tube may blow air at the back end of said pipe, or at the back part of said pipe, or at the middle part of said pipe, or at the front part of said pipe. Said pipe may be a long pipe. The two ends of said long pipe are placed separately, with one end placed in a position where odor is concentrated, and the other end placed in an area where the odor may be released, such has outdoors. Said compressed air tube may blow air at the back end of said long pipe, or at the back part of said long pipe, or at the middle part of said long pipe, or at the front part of said long pipe.

Said pipe can be an ordinary pipe with continuous identical axial diameter, and it can also be in the shape of a Venturi pipe with a reduced diameter in the middle of said pipe. Said compressed air tube can be a compressed air tube of continuous identical axial diameter, and it can also be in the form of a nozzle-shaped compressed air tube. The source of said compressed air can be a pump, or an air tank, or a pump in combination with an air tank, or an air compressor, or a bellows.

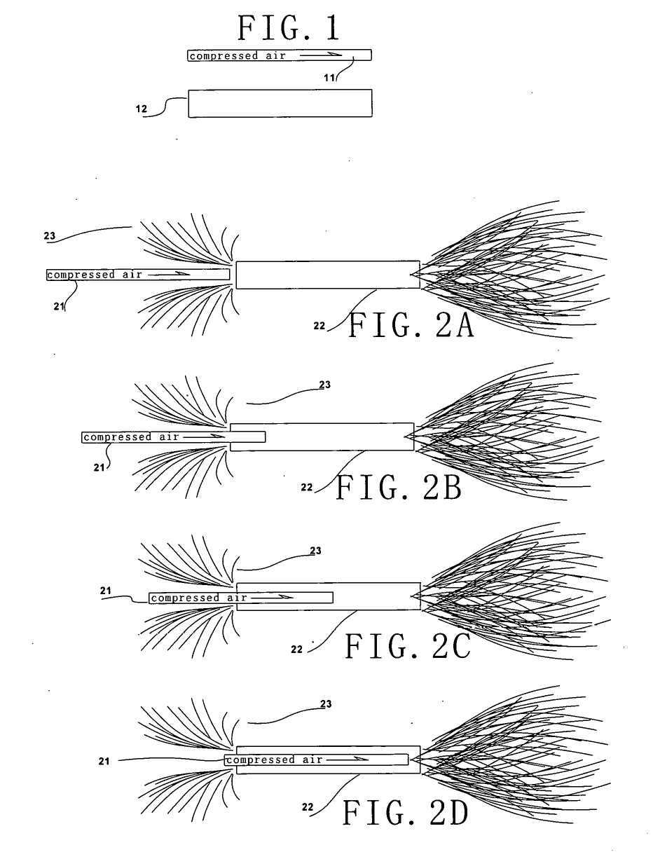

Embodiments 1, 2, 3 and 4, as shown in FIG. 1: a portion of the components in this application, compressed air tube 11, pipe 12. As shown in FIG. 2A to FIG. 2D, compressed air tube 21 blows air along the axis of pipe 22, in the same direction that pipe 22 is facing, which can create high speed airflow inside pipe 22, and draw the air 23 at the back end of said pipe to enter and flow in the same direction. There are 4 related positions that can create high speed airflow inside pipe 22, with compressed air tube 21 located at the back end of pipe 22 as shown in FIG. 2A, back part of pipe 22 as shown in FIG. 2B, middle part of pipe 22 as shown in FIG. 2C, and front part of pipe 22 as shown in FIG. 2D. These four related positions can all draw the air 23 at the back end of pipe 22, allowing the air to enter and flow in the same direction, drawing the toilet odor away.

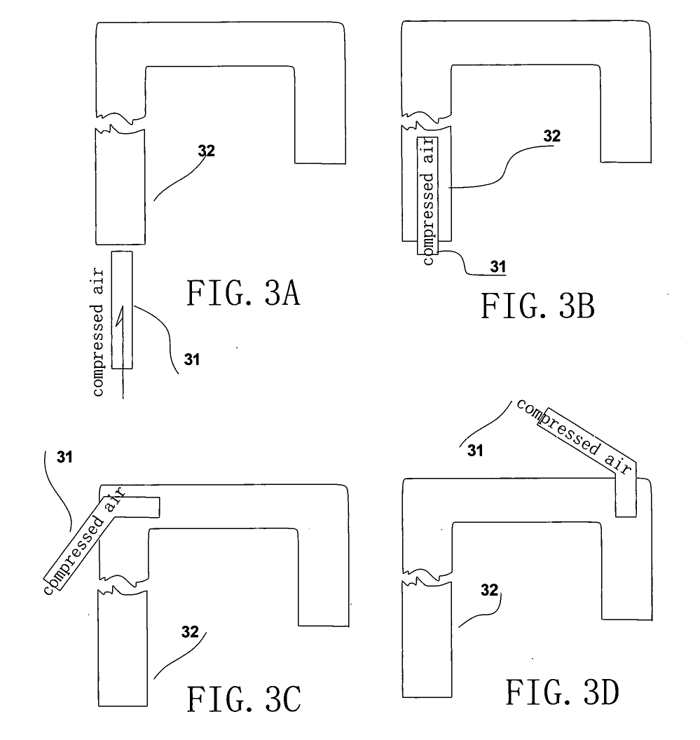

Embodiments 5, 6, 7, and 8, as shown in FIG. 3A to FIG. 3D: A long pipe 32 that connects the toilet to the place of release, conveniently removing odors. There are 4 related positions that can create high speed airflow inside long pipe 32, with compressed air tube 31 blowing air at the back end of long pipe 32 as shown in FIG. 3A, back part of long pipe 32 as shown in FIG. 3B, middle part of long pipe 32 as shown in FIG. 3C, and front part of long pipe 32 as shown in FIG. 3D. These four related positions can all draw the air at the back end of long pipe 32, allowing the air to enter and flow in the same direction, drawing the toilet odor away.

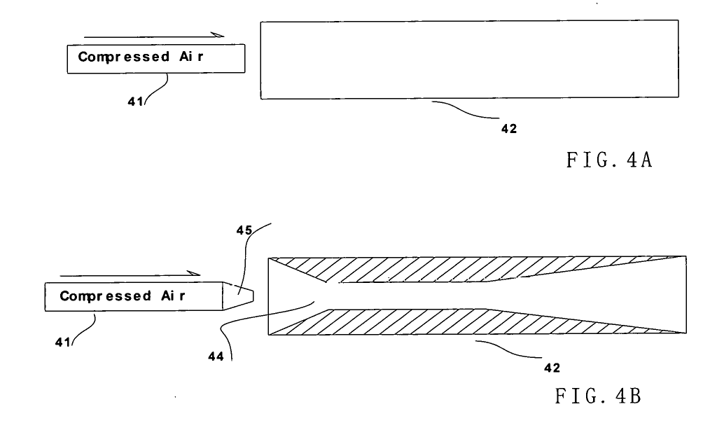

Embodiment 9: As shown in FIG. 4A: compressed air tube with continuous identical axial diameter 41, and pipe with continuous identical axial diameter 42. As shown in FIG. 4B: nozzle-shaped compressed air tube 41, nozzle 45, and pipe 42 with a reduced diameter in the center of the pipe, in the shape of a Venturi pipe 44. Compressed air tube 41 with nozzle 45 blows air at the back end of pipe 42 which is in the shape of a Venturi pipe with a reduced diameter in the middle of the pipe 44, the high speed airflow inside the pipe draws the air behind and it, drawing the toilet odor away.

Embodiments 10, 11, 12, 13, and 14: The nozzle-shaped compressed air tube blows air through the back end of the Venturi pipe with a reduced diameter in the middle of the pipe. The source of compressed air can be a pump, or an air tank, or a pump in combination with an air tank, or an air compressor, or a bellows.

1. A device that uses airflow to remove toilet odor, comprising:
a compressed air tube;
a pipe;
the compressed air as in the said compressed air tube is quickly passed through the said pipe, the high speed airflow in interior of the said pipe draws the air in the rear of the pipe to enter the pipe and flow in the same direction that the pipe is facing, also drawing the toilet odor away.

2. Regarding the device that uses airflow to remove toilet odor as said in claim 1, said compressed air tube may blow air at the back end of said pipe, or at the back part of said pipe, or at the middle part of said pipe, or at the front part of said pipe.

3. Regarding the device that uses airflow to remove toilet odor as said in claim 1, said pipe may be a long pipe, the two ends of said long pipe are placed separately, with one end placed in a position where odor is concentrated, and the other end placed in an area where the odor may be released, such as outdoors, said compressed air tube may blow air at the back end of said long pipe, or at the back part of said long pipe, or at the middle part of said long pipe, or at the front part of said long pipe.

4. Regarding the device that uses airflow to remove toilet odor as said in claim 1, said pipe can be an ordinary pipe with continuous identical axial diameter, or it may be in the shape of a Venturi pipe, with a reduced diameter in the middle of the pipe, said compressed air tube can be a compressed air tube with continuous identical axial diameter, it may also be a nozzle-shaped compressed air tube.

5. Regarding the device that uses airflow to remove toilet odor as said in claim 1, said source of compressed air may be a pump, or an air tank, or a pump in combination with an air tank, or an air compressor, or a bellows.
